(19) United States
(12) Patent Application Publication
(10) Pub. No.: US 2012/0116644 A1
(43) Pub. Date: May 10, 2012

(54) INTER-CYLINDER AIR-FUEL RATIO IMBALANCE ABNORMALITY DETECTION APPARATUS FOR MULTI-CYLINDER INTERNAL COMBUSTION ENGINE

(75) Inventor: Takumi Anzawa, Okazaki-shi (JP)

(73) Assignee: TOYOTA JIDOSHA KABUSHIKI KAISHA, Toyota-Shi (JP)

(21) Appl. No.: 13/282,908

(22) Filed: Oct. 27, 2011

(30) Foreign Application Priority Data
Nov. 5, 2010 (JP) 2010-248535

(51) Int. Cl. G01M 15/00

(52) U.S. Cl. 701/99

(57) ABSTRACT

An inter-cylinder air-fuel ratio imbalance abnormality detection apparatus includes an air-fuel ratio sensor disposed in an exhaust passage of a multi-cylinder internal combustion engine, and an abnormality detection unit that detects an inter-cylinder air-fuel ratio imbalance abnormality on the basis of a degree of variation in an output of the air-fuel ratio sensor. The abnormality detection unit detects the inter-cylinder air-fuel ratio imbalance abnormality by comparing a value of a parameter that correlates with the degree of variation in the output of the air-fuel ratio sensor with a predetermined abnormality determination value. The abnormality determination value is set individually for each of a plurality of preset operating regions of the internal combustion engine.

### CROSS-REFERENCE TO RELATED APPLICATIONS

This application claims the priority to Japanese Patent Application No. 2010-248535 filed on Nov. 5, 2010, which is incorporated herein by reference in its entirety including the specification, drawings and abstract.

### BACKGROUND OF THE INVENTION

1. Field of the Invention

The invention relates to an apparatus that detects an inter-cylinder air-fuel ratio imbalance abnormality of a multi-cylinder internal combustion engine, and more particularly to an apparatus that detects a comparatively large imbalance in air-fuel ratio among cylinders of a multi-cylinder internal combustion engine.

2. Description of Related Art

In a typical internal combustion engine that includes an exhaust gas control system employing a catalyst, a mixture ratio between air and fuel constituting an air-fuel mixture burned by the internal combustion engine, or in other words an air-fuel ratio, needs to be controlled to ensure that pollutants contained in the exhaust gas are purified by the catalyst with a high degree of efficiency. To control the air-fuel ratio, an air-fuel ratio sensor is provided in an exhaust passage of the internal combustion engine, and feedback control is implemented so that the air-fuel ratio detected by the air-fuel ratio sensor coincides with a predetermined target air-fuel ratio.

Meanwhile, in a multi-cylinder internal combustion engine, air-fuel ratio control is normally performed on all of the cylinders using identical control amounts, and therefore, even after the air-fuel ratio control is executed, an imbalance in an actual air-fuel ratio may occur among the cylinders. When the imbalance at this time is small, the imbalance can be absorbed by the air-fuel ratio feedback control, and the pollutants contained in the exhaust gas can be purified by the catalyst, and therefore, exhaust emissions are not affected. Hence, a small imbalance does not pose a particularly large problem.

However, for example, when a failure occurs in a fuel injection system or the like of at least one of the cylinders such that a large imbalance in the air-fuel ratio occurs among the cylinders, the exhaust emissions deteriorate so as to become problematic. Hence, an air-fuel ratio imbalance large enough to cause the exhaust emissions to deteriorate is preferably detected as an abnormality. In the case of an internal combustion engine for a vehicle, there is particularly a demand for an apparatus that detects an inter-cylinder air-fuel ratio imbalance abnormality in a vehicle-installed state (i.e. on board) to prevent a vehicle from traveling with deteriorated exhaust emissions, and in recent years, laws are being drafted in relation to exhaust emissions.

In an apparatus described in Japanese Patent Application Publication No. 2010-71259 (JP-A-2010-71259), for example, when an abnormal state, in which an output value of an air-fuel ratio sensor upstream of a catalyst diverges from a normal value, occurs, a learned value of a sub-feedback amount calculated on the basis of an output value of an air-fuel ratio sensor downstream of a catalyst is corrected to a value in the vicinity of an appropriate value.

When an air-fuel ratio imbalance abnormality occurs, variation in an air-fuel ratio sensor output increases. Therefore, an air-fuel ratio imbalance abnormality can be detected by monitoring the degree of variation in the air-fuel ratio sensor output. For example, an imbalance abnormality can be detected by comparing a parameter that correlates with the degree of variation in the air-fuel ratio sensor output to a predetermined abnormality determination value. The abnormality determination value is typically set at a fixed value.

However, according to the study by the inventor of the present invention, it has been found that it is not always appropriate to use a fixed abnormality determination value. In other words, when an air-fuel ratio imbalance abnormality is detected using a fixed abnormality determination value, a detection precision may decrease, leading to a false detection.

### SUMMARY OF THE INVENTION

The invention provides an inter-cylinder air-fuel ratio imbalance abnormality detection apparatus for a multi-cylinder internal combustion engine, in which an abnormality determination value is set appropriately so that a detection precision is improved and the likelihood of false detections is reduced.

An inter-cylinder air-fuel ratio imbalance abnormality detection apparatus for a multi-cylinder internal combustion engine according to an aspect of the invention includes: an air-fuel ratio sensor disposed in an exhaust passage of the multi-cylinder internal combustion engine; and an abnormality detection unit that detects an inter-cylinder air-fuel ratio imbalance abnormality on the basis of a degree of variation in an output of the air-fuel ratio sensor. The abnormality detection unit detects the inter-cylinder air-fuel ratio imbalance abnormality by comparing a value of a parameter that correlates with the degree of variation in the output of the air-fuel ratio sensor with a predetermined abnormality determination value, and the abnormality determination value is set individually for each of a plurality of preset operating regions of the internal combustion engine.

The abnormality determination value may be set at different values for at least two respective preset operating regions.

The abnormality determination value may be set at a larger value for the operating region having a higher engine rotation speed.

The abnormality determination value may be set at a larger value for the operating region having a greater intake air amount.

The parameter may be a value based on a difference in the output of the air-fuel ratio sensor between two different timings.

The air-fuel ratio sensor may be disposed in a collection portion of the exhaust passage, where exhaust gas from each cylinder of the multi-cylinder internal combustion engine collects.

According to the aspect of the invention described above, the abnormality determination value can be set appropriately, and therefore the detection precision can be improved and the likelihood of false detections can be reduced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram showing an internal combustion engine according to an embodiment of the invention;

FIG. 2 is a graph showing output characteristics of a catalyst front sensor and a catalyst rear sensor;

FIG. 3 is a graph showing variation in an air-fuel ratio sensor output corresponding to an inter-cylinder air-fuel ratio imbalance;

FIG. 4 is an enlarged view corresponding to an IV part in FIG. 3;

FIG. 5 is a graph showing actual measurement results of a decreasing rate of change with respect to a plurality of points in an engine operation region;

FIG. 6 is a graph showing a plurality of divided regions obtained by dividing the operating region shown in FIG. 5, and abnormality determination values set individually for the respective divided regions; and

FIG. 7 is a flowchart showing a routine for detecting an inter-cylinder air-fuel ratio imbalance abnormality.

### DETAILED DESCRIPTION OF EMBODIMENTS

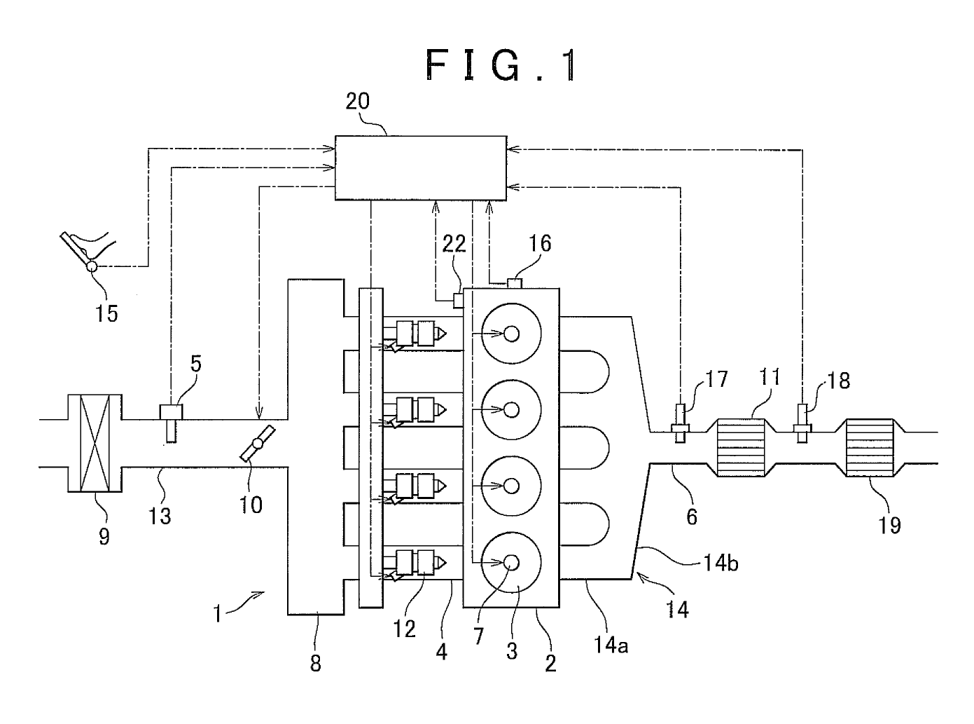

FIG. 1 is a schematic diagram showing an internal combustion engine according to an embodiment. As shown in the drawing, in an internal combustion engine (an engine) 1, an air-fuel mixture of fuel and air is combusted in the interior of a combustion chamber 3 formed in a cylinder block 2, and power is generated by causing a piston to reciprocate within the combustion chamber 3. The internal combustion engine 1 according to this embodiment is a multi-cylinder internal combustion engine installed in a vehicle, and more specifically an in-line four-cylinder spark ignition type internal combustion engine, or in other words a gasoline engine. Note, however, that the internal combustion engine to which the invention may be applied is not limited to this type of internal combustion engine, and as long as the internal combustion engine is a multi-cylinder internal combustion engine, there are no particular limitations on the number of cylinders, the type, and so on.

Although not shown in the drawing, in a cylinder head of the internal combustion engine 1, an intake valve that opens and closes an intake port and an exhaust valve that opens and closes an exhaust port are disposed for each cylinder. The respective intake valves and exhaust valves are opened and closed by a camshaft. A spark plug 7 for igniting the air-fuel mixture in the combustion chamber 3 is attached to a top portion of the cylinder head in relation to each cylinder.

The intake port of each cylinder is connected to a surge tank 8 serving as an intake air collection chamber via a branch pipe 4 for each cylinder. An intake pipe 13 is connected to an upstream side of the surge tank 8, and an air cleaner 9 is provided on an upstream end of the intake pipe 13. An air flow meter 5 for detecting an intake air flow (an amount of intake air per unit time, or in other words an intake air flow rate), and an electrically controlled throttle valve 10 are provided at the intake pipe 13 in order from the upstream side. The intake port, the branch pipe 4, the surge tank 8, and the intake pipe 13 together form an intake passage.

The intake passage, and particularly an injector (a fuel injection valve) 12 that injects the fuel into the intake port, is provided for each cylinder. The fuel injected from the injector 12 intermixes with the intake air to generate an air-fuel mixture, and when the intake valve is open, the air-fuel mixture is taken into the combustion chamber 3, compressed by the piston, and ignited and combusted by the spark plug 7.

Meanwhile, the exhaust port of each cylinder is connected to an exhaust manifold 14. The exhaust manifold 14 includes a branch pipe 14a for each cylinder, which serves as an upstream portion thereof, and an exhaust gas collection portion 14b serving as a downstream portion thereof. An exhaust pipe 6 is connected to a downstream side of the exhaust gas collection portion 14b. The exhaust port, the exhaust manifold 14, and the exhaust pipe 6 together form an exhaust passage. A part of the exhaust passage on a downstream side of the exhaust gas collection portion 14b of the exhaust manifold 14 forms a collection portion in which exhaust gas from the respective cylinders is collected.

Catalysts constituted by three-way catalysts, that is, an upstream catalyst 11 and a downstream catalyst 19, are attached in series to the upstream side and the downstream side of the exhaust pipe 6, respectively. First and second air-fuel ratio sensors, that is, a catalyst front sensor 17 and a catalyst rear sensor 18, are disposed upstream and downstream of the upstream catalyst 11, respectively. Each of the catalyst front sensor 17 and the catalyst rear sensor 18 detects an air-fuel ratio of the exhaust gas. The catalyst front sensor 17 and the catalyst rear sensor 18 are disposed in positions immediately before and immediately after the upstream catalyst 11. Each of the catalyst front sensor 17 and the catalyst rear sensor 18 detects the air-fuel ratio on the basis of an oxygen concentration of the exhaust gas. Hence, the single catalyst front sensor 17 is disposed in the collection portion of the exhaust passage. The catalyst front sensor 17 may be regarded as an “air-fuel ratio sensor” of the invention.

The spark plug 7, throttle valve 10, injector 12, and so on are electrically connected to an electronic control unit (abbreviated to ECU hereafter) 20 that controls the spark plug 7, throttle valve 10, injector 12, and so on. The ECU 20 may be regarded as an “abnormality detection unit” of the invention. The ECU 20 includes a central processing unit (CPU), a read only memory (ROM), a random access memory (RAM), an input/output port, a storage device, and so on, none of which are shown in the drawing. Further, as shown in the drawing, the aforementioned air flow meter 5, catalyst front sensor 17, and catalyst rear sensor 18, as well as a crank angle sensor 16 that detects a crank angle of the internal combustion engine 1, an accelerator operation amount sensor 15 that detects an accelerator operation amount, a coolant temperature sensor 22 that detects a temperature of coolant in the internal combustion engine 1, and various other sensors, are electrically connected to the ECU 20 via an analog-to-digital (A/D) converter and the like, not shown in the drawing. The ECU 20 controls an ignition timing, a fuel injection amount, a fuel injection timing, a throttle opening, and so on by controlling the spark plug 7, the throttle valve 10, the injector 12, and the like on the basis of detection values and so on from the various sensors so as to obtain a desired output. Note that the throttle opening is normally controlled to an opening corresponding to the accelerator operation amount.

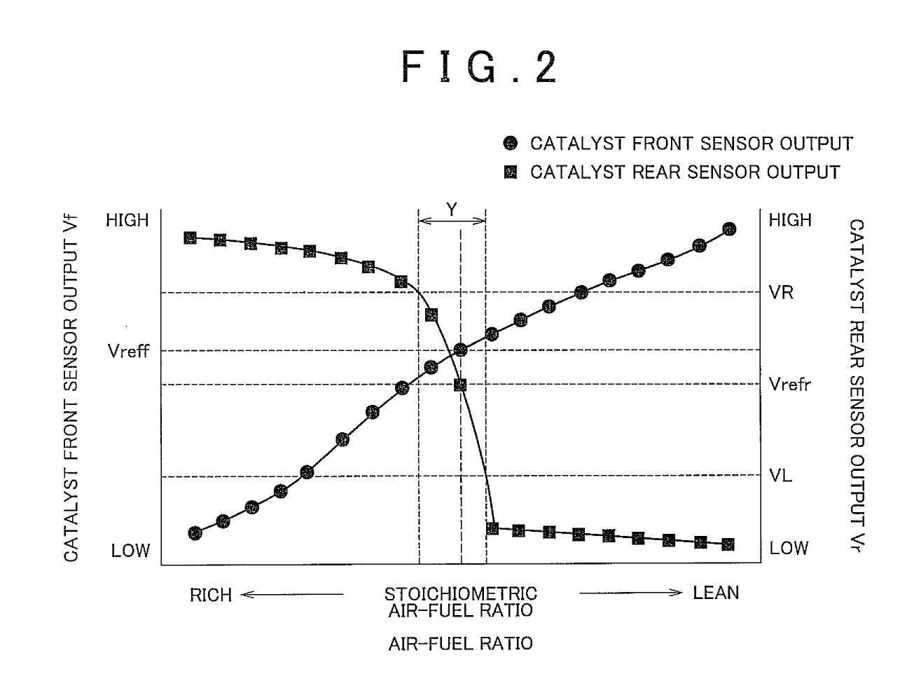

The catalyst front sensor 17 is constituted by a so-called wide range air-fuel ratio sensor capable of continuously detecting the air-fuel ratio over a comparatively wide range. FIG. 2 shows an output characteristic of the catalyst front sensor 17. As shown in the drawing, the catalyst front sensor 17 outputs a voltage signal Vf having a magnitude that is commensurate with the detected exhaust gas air-fuel ratio (a catalyst front air-fuel ratio A/Ff). An output voltage when the exhaust gas air-fuel ratio is at the stoichiometric air-fuel ratio (A/F=14.6, for example) is Vreff (approximately 3.3 V, for example).

The catalyst rear sensor 18, on the other hand, is constituted by a so-called O₂ sensor, a characteristic of which is that an output value varies rapidly about the stoichiometric air-fuel ratio. FIG. 2 shows an output characteristic of the catalyst rear sensor 18. As shown in the drawing, an output voltage when the exhaust gas air-fuel ratio (a catalyst rear air-fuel ratio A/Fr) is at the stoichiometric air-fuel ratio, or in other words a stoichiometric corresponding value, is Vrefr (approximately 0.45 V, for example). The output voltage of the catalyst rear sensor 18 varies within a predetermined range (0 to 1 (V), for example). When the exhaust gas air-fuel ratio is leaner than the stoichiometric air-fuel ratio, the output voltage of the catalyst rear sensor is lower than the stoichiometric corresponding value Vrefr, and when the exhaust gas air-fuel ratio is richer than the stoichiometric air-fuel ratio, the output voltage of the catalyst rear sensor is higher than the stoichiometric corresponding value Vrefr.

The upstream catalyst 11 and the downstream catalyst 19 simultaneously purify nitrogen oxide (NOx), hydro carbon (HC), and carbon monoxide (CO), which are pollutants contained in the exhaust gas, when the air-fuel ratio A/F of the exhaust gas flowing into the respective catalysts is in the vicinity of the stoichiometric air-fuel ratio. An air-fuel ratio range (a window) in which these three substances can be purified simultaneously with a high degree of efficiency is comparatively narrow.

The ECU 20 executes air-fuel ratio control (stoichiometric control) to control the air-fuel ratio of the exhaust gas flowing into the upstream catalyst 11 to the vicinity of the stoichiometric air-fuel ratio. This air-fuel ratio control is constituted by main air-fuel ratio control (main air-fuel ratio feedback control) executed so that the exhaust gas air-fuel ratio detected by the catalyst front sensor 17 coincides with the stoichiometric air-fuel ratio serving as a predetermined target air-fuel ratio, and auxiliary air-fuel ratio control (auxiliary air-fuel ratio feedback control) executed so that the exhaust gas air-fuel ratio detected by the catalyst rear sensor 18 coincides with the stoichiometric air-fuel ratio.

A case in which, for example, a failure occurs in the injector 12 of at least one of the cylinders such that an imbalance in the air-fuel ratio occurs among the cylinders, will be considered. In this case, for example, the fuel injection amount of a #1 cylinder is larger than the fuel injection amounts of #2, #3 and #4 cylinders such that the air-fuel ratio of the #1 cylinder deviates greatly to the rich side. By applying a comparatively large correction amount in the main air-fuel ratio feedback control described above, it may be possible to control the air-fuel ratio of a total amount of gas supplied to the catalyst front sensor 17 to the stoichiometric air-fuel ratio. When the cylinders are considered individually, however, it can be seen that the air-fuel ratio of the #1 cylinder is much richer than the stoichiometric air-fuel ratio while the air-fuel ratios of the #2, #3 and #4 cylinders are leaner than the stoichiometric air-fuel ratio, and therefore, although an overall balance corresponds to the stoichiometric air-fuel ratio, this condition is unfavorable in terms of emissions. Hence, in this embodiment, an apparatus is provided to detect this type of inter-cylinder air-fuel ratio imbalance abnormality.

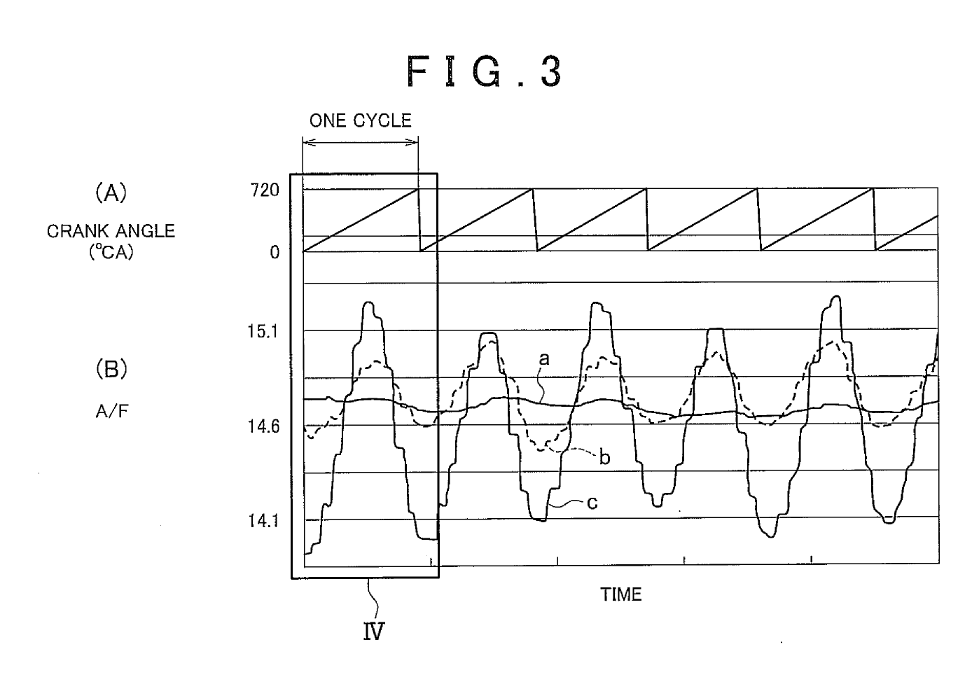

As shown in FIG. 3, the exhaust gas air-fuel ratio A/F detected by the catalyst front sensor 17 tends to vary periodically, where a single engine cycle (=720° C.A) corresponds to a single period. When an inter-cylinder air-fuel ratio imbalance occurs, the amount of variation within the single engine cycle increases. Air-fuel ratio lines a, b, c in a part (B) respectively indicate a case in which an imbalance does not occur, a case in which the air-fuel ratio of only one cylinder deviates to the rich side by an imbalance ratio of 20%, and a case in which the air-fuel ratio of only one cylinder deviates to the rich side by an imbalance ratio of 50%. As is evident from FIG. 3, an amplitude of the air-fuel ratio variation increases as the degree of the imbalance increases.

Here, the imbalance ratio (%) is a parameter expressing the degree of the imbalance in the air-fuel ratio among the cylinders. More specifically, the imbalance ratio is a value employed in a case where a deviation occurs in the fuel injection amount of only one of the cylinders to express a degree to which the fuel injection amount of the cylinder (an imbalanced cylinder) in which the fuel injection amount deviation has occurred deviates from the fuel injection amount of the cylinders (balanced cylinders) in which the fuel injection amount deviation has not occurred, or in other words a reference injection amount. When the imbalance ratio is represented by IB, the fuel injection amount of the imbalanced cylinder is represented by Qib, and the fuel injection amount of the balanced cylinders, or in other words the reference injection amount, is represented by Qs, IB=(Qib−Qs)/Qs. As the imbalance ratio IB increases, the fuel injection amount deviation of the imbalanced cylinder relative to the balanced cylinders increases, and therefore the degree of the imbalance in the air-fuel ratio increases.

Inter-Cylinder Air-Fuel Ratio Imbalance Abnormality Detection

As can be understood from the above description, when an air-fuel ratio imbalance abnormality occurs, variation in the output of the catalyst front sensor increases. Therefore, an air-fuel ratio imbalance abnormality can be detected by monitoring the degree of variation in the output of the catalyst front sensor. In this embodiment, a variation parameter is calculated as a parameter correlating with the degree of variation in the output of the catalyst front sensor, and an imbalance abnormality is detected by comparing the variation parameter to a predetermined abnormality determination value.

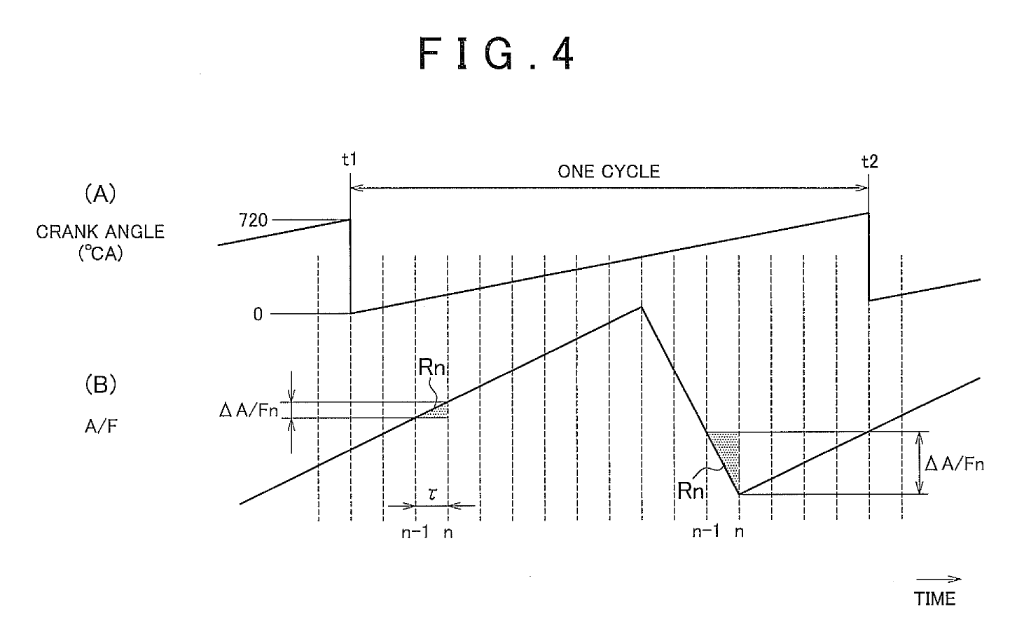

A method of calculating the variation parameter will be described. FIG. 4 is an enlarged view corresponding to an IV part of FIG. 3, and in particular showing variation in the output of the catalyst front sensor within a single engine cycle. Here, a value obtained by converting the output voltage Vf of the catalyst front sensor 17 into the air-fuel ratio A/F is used as the catalyst front sensor output. Note, however, that the output voltage Vf of the catalyst front sensor 17 may be used directly.

As shown in part (B) of FIG. 3, the catalyst front sensor output A/F sometimes increases and sometimes decreases. First, a case in which the catalyst front sensor output A/F increases will be described. The ECU 20 obtains the value of the catalyst front sensor output A/F at intervals of a predetermined sample period τ (a unit time, for example 4 ms) from the start of the single engine cycle. A difference ΔA/Fₙ between a value A/Fₙ obtained at a current timing (a second timing) and a value A/Fₙ₋₁ obtained at an immediately preceding timing (a first timing) is then determined using a following Equation (1). Note that the current timing and the immediately preceding timing are separated by a time τ. The difference ΔA/Fₙ may be referred to as a derivative value at the current timing.

[Equation 1]

ΔA/Fₙ=A/Fₙ−A/Fₙ₋₁ (1)

Further, the ECU 20 determines a ratio Rₙ between the difference ΔA/Fₙ and the time τ between the two timings, or in other words the ratio Rₙ of the difference ΔA/Fₙ to the time τ, using a following Equation (2).

[Equation 2]

Rₙ=(ΔA/Fₙ)/τ (2)

The ratio Rₙ corresponds to a gradient of a line over the single sample period τ, and may therefore be referred to simply as a gradient or a time rate of change.

In this embodiment, to improve a detection precision, the ratio Rₙ is accumulated in each sample period τ while the catalyst front sensor output A/F increases, and this accumulation operation is performed from a start time t1 to an end time t2 of the single engine cycle. A resulting accumulated value is then divided by a sample number N to determine an average value +Rv. Note that the sample number N varies in accordance with an engine rotation speed. The average value +Rv is calculated using a following Equation (3).

$$\begin{matrix}[ Equation 3 ] & \\ + Rv = ( {\sum }_{n = 1}^{N} {R}_{n} ) / N & ( 3 )\end{matrix}$$

To further improve the detection precision, the average value +Rv is accumulated over a predetermined number of engine cycles (100, for example), whereupon a resulting accumulated value is divided by the predetermined number to determine an average value. This finally determined average value serves as the variation parameter to be compared with the abnormality determination value. For convenience, this average value will be referred to as an “increasing rate of change” and represented by +R hereafter.

Next, a case in which the catalyst front sensor output A/F decreases will be described. A case in which the catalyst front sensor output A/F decreases is largely similar to a case in which the catalyst front sensor output A/F increases except that when the catalyst front sensor output A/F decreases, the air-fuel ratio difference ΔA/Fₙ and the ratio Rₙ are calculated as negative values, and therefore an average value −Rv of the ratio per engine cycle is calculated as an absolute value. In other words, the average value −Rv is calculated using a following Equation (4).

$$\begin{matrix}[ Equation 4 ] & \\ - Rv = \vert ( {\sum }_{n = 1}^{N} {R}_{n} ) / N \vert & ( 4 )\end{matrix}$$

Thereafter, similarly to a case in which the catalyst front sensor output A/F increases, the average value −Rv is accumulated over the predetermined number of engine cycles, whereupon a resulting accumulated value is divided by the predetermined number to determine an average value. This finally determined average value serves as the variation parameter to be compared with the abnormality determination value. For convenience, this average value will be referred to as a “decreasing rate of change” and represented by −R hereafter.

The increasing rate of change +R and the decreasing rate of change −R increase as the degree of variation in the catalyst front sensor output increases. Hence, the increasing rate of change +R and the decreasing rate of change −R correlate with the degree of variation in the catalyst front sensor output.

Note that the variation parameter is not limited to the increasing rate of change +R and the decreasing rate of change −R described above, and other values may be used. For example, the average values +Rv, −Rv of the ratio R over a single engine cycle or the ratio R at a single given timing within the single engine cycle may be used as the variation parameter. Alternatively, an output difference ΔA/F at a single given timing or an average value of the output difference ΔA/F at a plurality of timings may be used as the variation parameter. In other words, the ratio R may be replaced by the output difference ΔA/F. Furthermore, variation in the catalyst front sensor output does not have to be separated into increasing variation and decreasing variation, and instead, the variation parameter may be calculated on the basis of an absolute value of the output difference ΔA/F.

Further, any value that correlates with the degree of variation in the catalyst front sensor output may be used as the variation parameter. For example, the variation parameter may be calculated on the basis of a difference (a so-called peak to peak) between a maximum value and a minimum value of the catalyst front sensor output over a single engine cycle, since this difference increases as the degree of variation in the catalyst front sensor output increases.

According to the study by the inventor of the present invention, it has been found that it is not always appropriate to set the abnormality determination value, which is compared with the variation parameter, at a fixed value. Hence, when an air-fuel ratio imbalance abnormality is detected using an abnormality determination value that is fixed at all times, the detection precision may decrease, leading to a false detection.

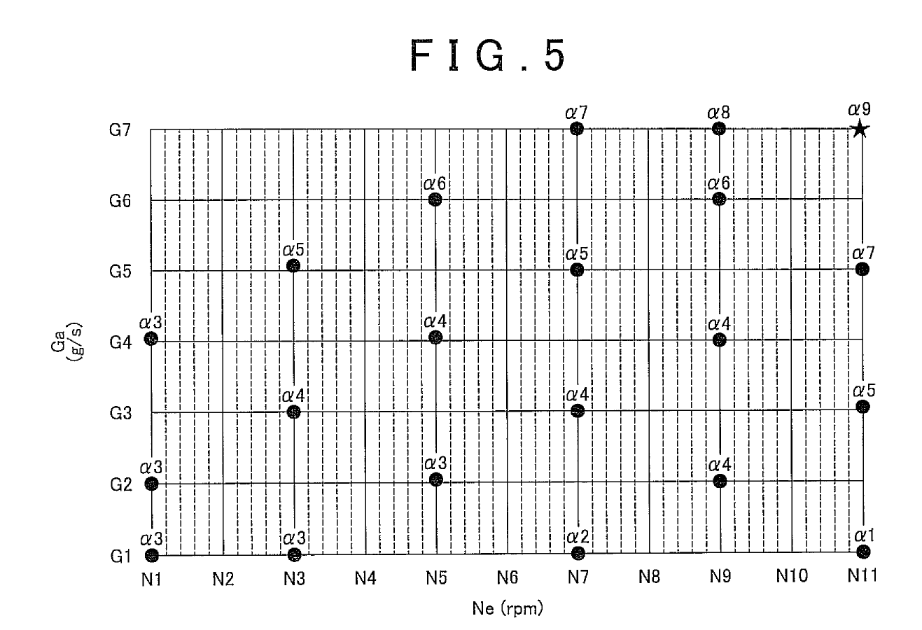

This finding is illustrated in FIG. 5. FIG. 5 shows the actually measured decreasing rate of change −R in a case where a deviation to the rich side corresponding to a criterion (a boundary between normality and abnormality) has occurred, with regard to each of a plurality of points in an engine operation region defined by an engine rotation speed Ne (rpm) and an intake air amount Ga (g/s). Note that the engine rotation speed Ne is synonymous with the engine rotation rate.

Here, as shown in FIG. 4, when a deviation to the rich side has occurred in only one cylinder, the air-fuel ratio of the exhaust gas discharged from this cylinder is extremely rich, and therefore, upon reception of this exhaust gas, the output of the catalyst front sensor varies rapidly to the rich side, or in other words decreases rapidly. Hence, in this case, a deviation abnormality to the rich side is detected using only the decreasing rate of change −R.

Referring to FIG. 5, rotation speeds N1 to N11 exist at equal intervals with regard to the engine rotation speed Ne, and intake air amounts G1 to G7 exist at equal intervals with regard to the intake air amount Ga. In this embodiment, imbalance abnormality detection is performed only in a rotation speed range from N1 to N11 and an intake air amount range from G1 to G7. For example, N1=2200 (rpm), N11=2500 (rpm), G1=16 (g/s), and G7=22 (g/s). Thus, imbalance abnormality detection is performed only in a partial operating region of the entire operating region of the engine. The operating region in which imbalance abnormality detection is performed will be referred to as a detection region.

As is evident from FIG. 5, when at least one of the engine rotation speed Ne (rpm) and the intake air amount Ga (g/s) differs, the actually measured value tends to differ. In FIG. 5, α1 to α9 are actually measured values (actually measured values of the decreasing rate of change −R). The values of α1 to α9 increase in order from α1 to α9 (α1<α2< . . . <α8<α9). For example, the actually measured value when the engine rotation speed Ne is N1 and the intake air amount Ga is G1 (Ne=N1 and Ga=G1) is α3, whereas the actually measured value when the engine rotation speed Ne is N3 and the intake air amount Ga is G3 (Ne=N3 and Ga=G3) is α4. In short, the actually measured value tends to increase as the engine rotation speed Ne increases and as the intake air amount Ga increases. A maximum actually measured value within the detection region is α9 (indicated by a star symbol), at which the engine rotation speed Ne corresponds to the maximum engine rotation speed N11 and the intake air amount Ga corresponds to the maximum intake air amount G7.

For example, if α3 is set as a fixed abnormality determination value, and the actually measured value α8 is obtained under engine operating conditions of N11 as the engine rotation speed Ne and G7 as the intake air amount Ga (Ne=N11 and Ga=G7), it is determined that an imbalance abnormality has occurred, because α3 is smaller than α8 (α3<α8). However, since α8 is in reality smaller than α9 (α8<α9), it should be determined that an imbalance abnormality has not occurred, or in other words that the condition is normal. Hence, in this case, a false detection is made.

Conversely, for example, if the maximum value α9 is set as the fixed abnormality determination value, and the actually measured value α5 is obtained under engine operating conditions of N1 as the engine rotation speed Ne and G1 as the intake air amount Ga (Ne=N1 and Ga=G1), it is determined that the condition is normal, because α5 is smaller than α9 (α5<α9). However, since α3 is in reality smaller than α5 (α3<α5), it should be determined that an imbalance abnormality has occurred. Hence, a false detection is made in this case also. An imbalance abnormality is particularly unlikely to be detected when a large and fixed abnormality determination value is set.

Hence, when the abnormality determination value is determined uniformly without taking into account the engine operating conditions during abnormality detection, the detection precision may deteriorate, leading to a false detection.

Therefore, in this embodiment, the abnormality determination value is set individually for each of a plurality of preset operating regions of the engine. In so doing, the abnormality determination value can be set appropriately, enabling an improvement in the detection precision, and as a result, false detections can be prevented.

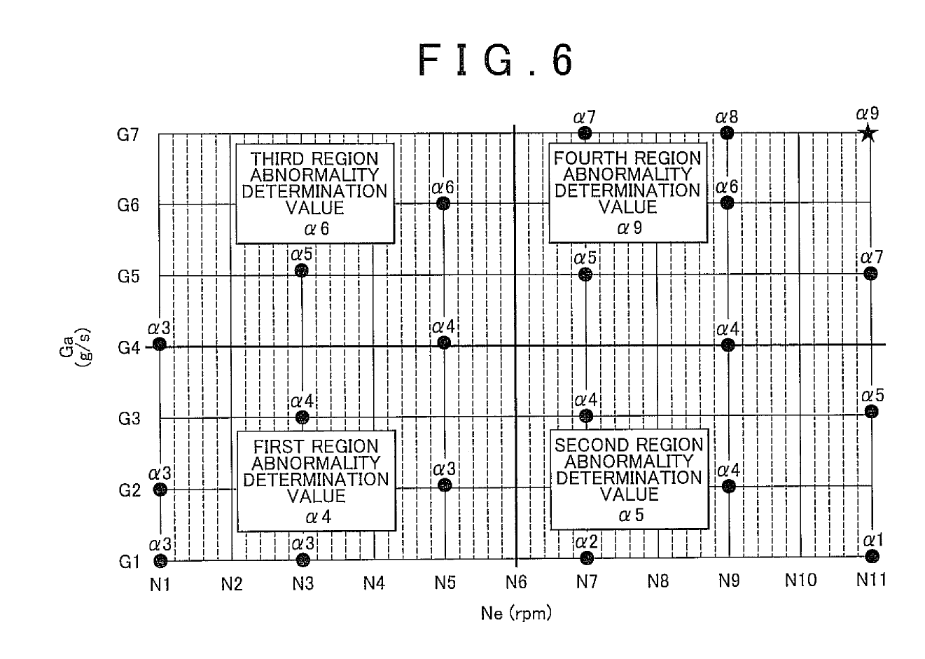

FIG. 6 shows first to fourth regions obtained by dividing the detection region into four regions, and abnormality determination values set individually for the respective regions. In a first region where the engine rotation speed Ne is equal to or higher than N1 and equal to or lower than N6 and the intake air amount Ga is equal to or larger than G1 and equal to or smaller than G4 (N1≦Ne≦N6 and G1≦Ga≦G4), the abnormality determination value is set at α4. In a second region where the engine rotation speed Ne is higher than N6 and equal to or lower than N11 and the intake air amount Ga is equal to or larger than G1 and equal to or smaller than G4 (N6<Ne≦N11 and G1≦Ga≦G4), the abnormality determination value is set at α5. In a third region where the engine rotation speed Ne is equal to or higher than N1 and equal to or lower than N6 and the intake air amount Ga is larger than G4 and equal to or smaller than G7 (N1≦Ne≦N6 and G4<Ga≦G7), the abnormality determination value is set at α6. In a fourth region where the engine rotation speed Ne is higher than N6 and equal to or lower than N11 and the intake air amount Ga is larger than G4 and equal to or smaller than G7 (N6<Ne≦N11 and G4<Ga≦G7), the abnormality determination value is set at α9. These abnormality determination values are set in accordance with the actual measurement data shown in FIG. 5. Preferably, the different abnormality determination values are set for at least two respective operating regions.

By setting different appropriate abnormality determination values for the respective regions in this manner, the detection precision can be improved, and as a result, false detections can be prevented.

Further, in a case where the abnormality determination value is fixed, the detection region may be narrowed in accordance with the abnormality determination value, but in so doing, a detection frequency decreases. According to this embodiment, the abnormality determination value is set individually for each preset region, and therefore the detection region can be enlarged while securing a sufficient detection frequency.

Inter-Cylinder Air-Fuel Ratio Imbalance Abnormality Detection Routine

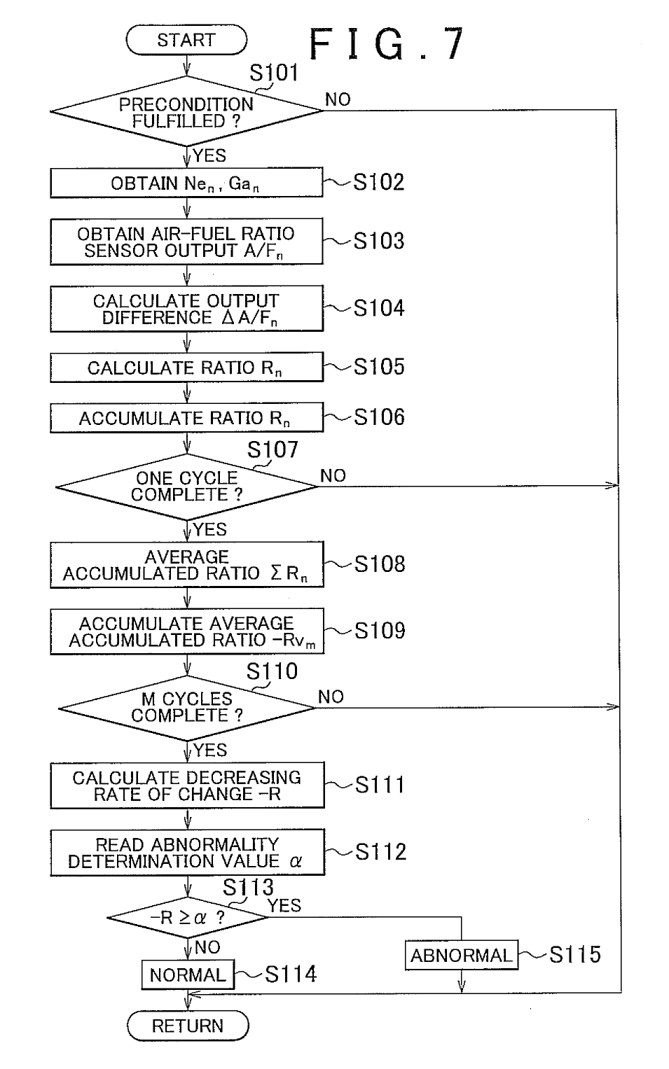

Next, using FIG. 7, an inter-cylinder air-fuel ratio imbalance abnormality detection routine will be described. This routine is executed repeatedly by the ECU 20, for example, at intervals of the aforesaid sample period τ.

First, in Step S101, a determination is made as to whether or not a predetermined precondition for performing an abnormality detection is fulfilled. The precondition is fulfilled when each of the following conditions is fulfilled. (1) Engine warm-up is complete. Warm-up is considered to be complete when the coolant temperature detected by the coolant temperature sensor 22 equals or exceeds a predetermined value, for example. (2) At least the catalyst front sensor 17 is active. (3) The engine is operating in a steady state. (4) Stoichiometric control is underway. (5) The engine is operating within the detection region. (6) The output A/F of the catalyst front sensor 17 is decreasing.

When the precondition is not fulfilled, the routine is terminated. When the precondition is fulfilled, on the other hand, an engine rotation speed Neₙ and an intake air amount Gaₙ at the current timing are obtained in Step S102.

Next, an output A/Fₙ of the catalyst front sensor 17 (the air-fuel ratio sensor) at the current timing is obtained in Step S103, whereupon an output difference ΔA/Fₙ at the current timing is calculated using Equation (1) in Step S104.

Next, a ratio Rₙ at the current timing is calculated using Equation (2) in Step S105, whereupon the ratio Rₙ is accumulated in Step S106. An accumulated value of the ratio at the current timing, or in other words an accumulated ratio ΣRₙ, is then determined using a following Equation (5).

[Equation 5]

ΣRₙ=ΣRₙ₋₁+Rₙ (5)

Next, in Step S107, a determination is made as to whether or not a single engine cycle is complete. When the engine cycle is not complete, the routine is terminated, and when the engine cycle is complete, the routine advances to Step S108.

In Step S108, the accumulated ratio ΣRₙ is averaged by being divided by the sample number N in accordance with Equation (4). Then, in Step S109, an average accumulated ratio −Rvₘ is accumulated. A resulting accumulated value ΣRvₘ is then determined using a following Equation (6).

[Equation 6]

Σ−Rvₘ=Σ−Rvₘ₋₁+−Rvₘ (6)

Thus, calculation and accumulation of the average accumulated ratio −Rvₘ are executed every time a single engine cycle is completed.

Next, in Step S110, a determination is made as to whether or not M engine cycles have been completed. When M engine cycles have not been completed, the routine is terminated, and when M engine cycles have been completed, the routine advances to Step S111.

In Step S111, the final accumulated value Σ−Rvₘ is averaged by being divided by M, whereby the decreasing rate of change −R is calculated.

Next, in Step S112, the abnormality determination value α is read from a map stored in the ECU 20 in advance in the form shown in FIG. 6. At this time, all of the values of the engine rotation speed Ne and the intake air amount Ga obtained previously in Step S102 (N×M units, respectively) are averaged, and the abnormality determination value α corresponding to the average value of the engine rotation speed Ne and the average value of the intake air amount Ga is read from the map. For example, when the average value of the engine rotation speed Ne is N4 and the average value of the intake air amount Ga is G3, an abnormality determination value α of 0.040 in the first region is read from the map.

Next, in Step S113, the decreasing rate of change −R is compared with the abnormality determination value α.

When the decreasing rate of change −R is smaller than the abnormality determination value α, the routine advances to Step S114, where it is determined that an imbalance abnormality has not occurred, or in other words that the condition is normal. The routine is then terminated.

When the decreasing rate of change −R equals or exceeds the abnormality determination value α, on the other hand, the routine advances to Step S115, where it is determined that an imbalance abnormality has occurred, or in other words that the condition is abnormal. The routine is then terminated. Note that a warning device such as a check lamp is preferably activated at the same time as the time when an abnormality is determined, in order to notify a user of the abnormality.

The embodiment of the invention has been described in detail above, but the invention may be realized in various other embodiments. For example, in the above embodiment, a deviation abnormality to the rich side is detected using only the air-fuel ratio sensor output obtained when the air-fuel ratio sensor output decreases (varies to the rich side). However, the air-fuel ratio sensor output obtained during an increase (during variation to the lean side) may be used alone, or the air-fuel ratio sensor output obtained when the air-fuel ratio sensor output decreases and when the air-fuel ratio sensor output increases may be used. Further, a deviation abnormality to the lean side may be detected as well as a deviation abnormality to the rich side. Alternatively, an air-fuel ratio imbalance abnormality may be detected over a wide range without differentiating between a deviation to the rich side and a deviation to the lean side.

Furthermore, in the above embodiment, a part of the entire operating region of the internal combustion engine is set as the detection region, whereupon the detection region is divided into a plurality of regions. However, the division method is not limited thereto, and instead, the entire operating region may be divided into a plurality of regions, for example.

Thus, the embodiment of the invention that has been disclosed in the specification is to be considered in all respects as illustrative and not restrictive. The technical scope of the invention is defined by claims, and all changes which come within the meaning and range of equivalency of the claims are therefore intended to be embraced therein.

What is claimed is:

1. An inter-cylinder air-fuel ratio imbalance abnormality detection apparatus for a multi-cylinder internal combustion engine,
the inter-cylinder air-fuel ratio imbalance abnormality detection apparatus comprising:
an air-fuel ratio sensor disposed in an exhaust passage of the multi-cylinder internal combustion engine; and
an abnormality detection unit that detects an inter-cylinder air-fuel ratio imbalance abnormality on the basis of a degree of variation in an output of the air-fuel ratio sensor, wherein
the abnormality detection unit detects the inter-cylinder air-fuel ratio imbalance abnormality by comparing a value of a parameter that correlates with the degree of variation in the output of the air-fuel ratio sensor with a predetermined abnormality determination value, and
the abnormality determination value is set individually for each of a plurality of preset operating regions of the internal combustion engine.

2. The inter-cylinder air-fuel ratio imbalance abnormality detection apparatus according to claim 1, wherein the abnormality determination value is set at different values for at least two respective preset operating regions.

3. The inter-cylinder air-fuel ratio imbalance abnormality detection apparatus according to claim 1, wherein the abnormality determination value is set at a larger value for the operating region having a higher engine rotation speed.

4. The inter-cylinder air-fuel ratio imbalance abnormality detection apparatus according to claim 1, wherein the abnormality determination value is set at a larger value for the operating region having a greater intake air amount.

5. The inter-cylinder air-fuel ratio imbalance abnormality detection apparatus according to claim 1, wherein the parameter is a value based on a difference in the output of the air-fuel ratio sensor between two different timings.

6. The inter-cylinder air-fuel ratio imbalance abnormality detection apparatus according to claim 5, wherein the parameter is a value based on a ratio of the difference in the output of the air-fuel ratio sensor between the two timings to an amount of time between the two timings.

7. The inter-cylinder air-fuel ratio imbalance abnormality detection apparatus according to claim 1, wherein the air-fuel ratio sensor is disposed in a collection portion of the exhaust passage, where exhaust gas from each cylinder of the multi-cylinder internal combustion engine collects.

8. The inter-cylinder air-fuel ratio imbalance abnormality detection apparatus according to claim 7, wherein a catalyst is provided in the exhaust passage, and the air-fuel ratio sensor is disposed upstream of the catalyst.
